(19) United States
(12) Patent Application Publication
(10) Pub. No.: US 2009/0104383 A1
(43) Pub. Date: Apr. 23, 2009

(54) Transfer Paper for Dry Transfer Printing and Method of Dry Transfer Printing with the Same

(75) Inventors: Hisashige Terao, Osaka (JP); Eiji Yamada, Osaka (JP); Genshi Yamamoto, Kyoto (JP)

Correspondence Address: BIRCH STEWART KOLASCH & BIRCH, PO BOX 747, FALLS CHURCH, VA, 22040-0747, US

(73) Assignees: Art Inc., Kyoto (JP); Genshi Yamamoto, Kyoto (JP)

(21) Appl. No.: 12/225,711

(22) PCT Filed: Mar. 26, 2007
(86) PCT No.: PCT/JP2007/056217

§ 371 Date: Dec. 4, 2008

(30) Foreign Application Priority Data
Mar. 28, 2006 (JP) 2006-119822
May 2, 2006 (JP) 2006-154034
Aug. 1, 2006 (JP) 2006-209793

(51) Int. Cl. B41M 5/00; B44C 1/165

(52) U.S. Cl. 428/32.1; 156/230; 428/195.1

(57) ABSTRACT

A transfer paper for use in dry transfer printing in witch a transfer paper is pressed with heating against a natural or synthetic fibrous material to transfer an ink thereto. It is characterized in that it is produced by applying a water-soluble dye ink to a transfer paper having a release agent layer and an ink-receiving layer overlying the layer and the ink-receiving layer comprises a hydrophilic synthetic resin and a hydrophilic adhesive, the hydrophilic adhesive being contained in an amount of 1-50 parts by weight per 100 parts by weight of the hydrophilic synthetic resin. Also provided is a method of dry transfer printing characterized by pressing the transfer paper for dry transfer printing against a natural or synthetic fibrous material with heating to thereby transfer the water-soluble dye ink applied to the transfer paper to the fibrous material and subsequently fixing the ink.

The present invention relates to a transfer paper for dry transfer printing and method of dry transfer printing with the same.

For drawing a design fast and finely on a cloth with a dye, screen printing, roller printing, rotary screen printing, gravure printing, and transfer printing based on the above printing techniques have conventionally been known, and also industrially employed. These plate printing techniques have, however, the following drawbacks.

i. The number of applicable colors is limited.
ii. Although printing with pattern frames of decomposed three primary colors can express a multicolor image, it is difficult to adjust the hue and density of the colors composed from the three primary colors.
iii. Reproducibility of the printing effect is prone to be degraded because of forming multiple layers.

Besides, problems of loss and waste of materials have been pointed out, such as the expensive plate making cost in the case of a small-lot production, and necessity of preparing a surplus amount of color paste than is actually necessary for the printing process.

As a new printing method that eliminates the foregoing problems, a plateless printing technique, performed through processing an image by a computer and printing the image with the ink-jet system, is being spotlighted. The plateless printing is being developed in the transfer printing field in addition to direct printing on a cloth, and the practical use thereof is being launched. The transfer printing based on the plateless printing technique includes applying a dye ink (design) on a paper with an ink-jet printer to create a transfer paper, and transferring the dye on the transfer paper to a natural or synthetic fiber material. This technique has, however, such drawback that when printing a dye ink in small dots with the ink-jet printer on an uncolored transfer paper, uniformity in printing effect among the dots becomes insufficient, and that the dye solution oozes out thus destroying the delicacy.

As a solution of those drawbacks, a method has been proposed that includes applying a water-soluble paste to a transfer base paper to which a water-soluble varnish or organic solvent-soluble varnish is applied as a release agent, and executing the ink-jet printing on such paper so that the dye ink is uniformly retained in the paste layer.

These techniques are useful in the case of executing dry sublimation transfer printing on a polyester fiber with a disperse dye that sublimes by heat, and executing wet transfer, of pressing the transfer paper onto a water-moistened cloth to thereby transfer the dye, on a cellulose-based fiber or protein-based fiber. However, the wet transfer technique is prone to lack in delicacy and reproducibility of the design. Besides, this type of transfer technique cannot be applied to the dry transfer to a cellulose-based fiber or protein-based fiber material. In other words, although the process up to printing the dye ink on the uncolored transfer paper can be satisfactorily performed, it is impossible to transfer the dye from the transfer paper to the cloth in the dry process.

Meanwhile, the patent document 1 discloses a transfer paper having on a surface thereof a release layer, and a coating layer (ink-receiving layer) including a paste and an adhesive as an outer layer, which achieves a transfer rate of the paste and the adhesive of 98 to 100% to a woven cloth, when the coating layer of the transfer paper and the cloth are put together and pressed against each other at 1 to 4 kg/cm². The coating layer of such transfer paper primarily contains the paste with a small amount of the adhesive, and the transfer of the paste and adhesive to the woven cloth is performed exclusively by pressing, without heating. This processing method is, however, quite impractical. More specifically, the ink-jet printed transfer paper is normally wound up over several hundred meters and stored for a certain period before being subjected to the transfer process, however if the coating layer is peeled off with a pressure as low as 1 to 4 kg/cm² or so, the wound transfer paper incurs the transfer to the rear surface, and hence it is practically impossible to wind the transfer paper. Consequently, the foregoing technique provides low transfer paper stability, and poor practical value.

The terms related to the transfer paper may be used in the following meanings, in this specification and the claims.

(1) Transfer base paper: paper or film with a release agent applied thereto

(2) Uncolored transfer paper: the transfer base paper with the ink-receiving layer applied thereto

(3) Transfer paper: the uncolored transfer paper with the dye ink applied thereto

### PROBLEM TO BE SOLVED BY THE INVENTION

An object of the present invention is to provide a transfer paper for dry transfer printing, to be used in a dry transfer printing method including heat-pressing the transfer paper on a fiber material to thereby transfer a dye (design) from the transfer paper to the fiber material, which is applicable to printing on a natural fiber material such as a cellulose-based fiber or protein-based fiber, or to a synthetic fiber material, capable of giving delicacy and reproducibility to the printed design, and allows executing quick delivery in what is known as plateless printing. The present invention also provides a dry transfer printing method that employs such transfer paper for dry transfer printing, thereby achieving high delicacy and reproducibility of the printed design, cost reduction, and also ecological benefits.

### MEANS FOR SOLVING THE PROBLEM

As a result of extensive studies on the printing method for a cloth based on the ink-jet printing, in particular the dry transfer technique, the present inventors have discovered a new dry transfer printing method that includes applying to a known transfer base paper an ink-receiving layer including a combination of a hydrophilic synthetic resin and hydrophilic paste that soften or melt with heat and easily peel off from the release agent layer, to thereby form an uncolored transfer paper, applying a water-soluble dye ink to the uncolored transfer paper by ink-jet printing or the like thus to form a transfer paper, and performing the dry transfer printing with the transfer paper on a cloth, and such method enables performing quick delivery by the plateless printing, easily achieving a delicate and high-quality design, and achieving low cost and ecological benefit.

Thus, the present invention provides a transfer paper for dry transfer printing, to be used in a dry transfer printing process including heat-pressing the transfer paper on a natural or a synthetic fiber material to thereby transfer a design,

formed through applying a water-soluble dye ink,

to an uncolored transfer paper including a release agent layer and an ink-receiving layer formed thereon,

wherein the ink-receiving layer contains a hydrophilic synthetic resin and a hydrophilic paste,

in a proportion of 1 to 50 parts by weight of the hydrophilic paste against 100 parts by weight of the hydrophilic synthetic resin (claim 1).

The present invention also provides the transfer paper for dry transfer printing according to claim 1, wherein the hydrophilic synthetic resin is a resin that softens or melts when heated (claim 2).

The present invention also provides the transfer paper for dry transfer printing according to claim 1 or 2, wherein the hydrophilic synthetic resin is one or a mixture of at least two selected from a water-soluble polyester resin, a water-soluble urethane resin, a water-soluble urethane-modified ether resin, and a water-soluble polyethyleneoxide resin (claim 3).

The present invention also provides the transfer paper for dry transfer printing according to any of claims 1 to 3, wherein the hydrophilic paste is a paste composed essentially of a natural material, a semi-synthetic material or a water-soluble synthetic polymer (claim 4).

Examples of the paste composed of a natural material or a semi-synthetic material include a seaweed, a cellulose-derived paste, a modified starch paste, and a natural gum. Accordingly, the present invention also provides the transfer paper for dry transfer printing according to claim 4, wherein the hydrophilic paste is one or a mixture of at least two selected from a seaweed, a cellulose-derived paste, a modified starch paste, a water-soluble synthetic polymer and a natural gum (claim 5).

More specific examples of the hydrophilic paste include a seaweed such as sodium alginate, a cellulose-derived paste such as etherified carboxymethyl cellulose or hydroxyethyl cellulose, a modified starch paste such as etherified starch or esterified starch, a water-soluble synthetic polymer such as sodium polyacrylate or polyvinyl alcohol, and a natural gum such as etherified tamarind gum or etherified guar gum. These are preferable because of, for example, not disturbing a reactive dye from adhering to a fiber.

The present invention also provides the transfer paper for dry transfer printing according to any of claims 1 to 5, wherein the ink-receiving layer is composed essentially of a mixture of the hydrophilic synthetic resin and the hydrophilic paste (claim 6).

The present invention also provides the transfer paper for dry transfer printing according to any of claims 1 to 5, wherein the ink-receiving layer has a two-layer structure consisting of a layer composed of the hydrophilic synthetic resin and a layer formed thereon composed of the hydrophilic paste (claim 7).

The present invention also provides the transfer paper for dry transfer printing according to any of claims 1 to 7, wherein the ink-receiving layer further comprises one or at least two selected from an acidic substance or an alkaline chemical, a surface tension reducer, a thickening agent, a foil transfer binder paste, a mineral and a moisture-retaining agent (claim 8).

The present invention also provides the transfer paper for dry transfer printing according to any of claims 1 to 8, wherein the release agent layer is a synthetic resin layer soluble in an organic solvent (claim 9).

The present invention also provides the transfer paper for dry transfer printing according to claim 9, wherein the synthetic resin soluble in an organic solvent is one or a mixture of at least two selected from a silicon resin, a fluorine resin, a polypropylene resin, a polyethylene resin, an acrylic resin, an alkyd resin, a polyamide resin, a phenol resin, a stearic acid resin and a polyester resin (claim 10).

The present invention also provides the transfer paper for dry transfer printing according to any of claims 1 to 10, wherein the water-soluble dye ink is an ink of a dye selected from a reactive dye, an acidic dye, a metal complex salt dye and a direct dye (claim 11).

The present invention also provides the transfer paper for dry transfer printing according to claim 11, wherein the water-soluble dye ink comprises a reactive dye (claim 12).

The present invention also provides the transfer paper for dry transfer printing according to claim 11, wherein the ink receiving layer comprises an alkaline chemical and a moisture retaining agent (claim 13).

The present invention also provides the transfer paper for dry transfer printing according to claim 13, wherein the alkaline chemical is a salt of a weak acid and a strong alkali (claim 14).

The present invention provides, in addition to the foregoing transfer paper for dry transfer printing, a dry transfer printing method characterized in employing the transfer paper for dry transfer printing, so as to achieve high delicacy and reproducibility of the design.

Thus, the present invention provides a dry transfer printing method comprising heat-pressing the transfer paper according to any of claims 1 to 14 on a natural or synthetic fiber material, to thereby transfer the water-soluble dye ink retained by the transfer paper to the fiber material, and executing a fixing process (claim 15).

The present invention also provides the dry transfer printing method according to claim 15, wherein the fixing process is a steaming process (claim 16).

The present invention also provides the dry transfer printing method according to claim 15 or 16, wherein the natural or synthetic fiber material is one of a woven, a knitted, and a non-woven fabric made of one or at least two fiber materials selected from a cellulose-based fiber material, a protein-based fiber material, and a synthetic fiber material (claim 17).

Here, the cellulose-based fiber material can be exemplified by cotton, hemp, lyocell, and rayon (polynosic rayon, viscose rayon, cupra rayon and so on); the protein-based fiber material by silk, wool, and animal hair; and the synthetic fiber material by nylon, vinylon, and so forth.

The present invention also provides the dry transfer printing method according to any of claims 15 to 17, wherein the water-soluble dye ink comprises a reactive dye; the natural or synthetic fiber material is a natural fiber material; and the natural fiber material is subjected to a pre-treatment by an alkaline chemical in advance (claim 18).

The present invention also provides the dry transfer printing method according to any of claims 15 to 17, wherein the water-soluble dye ink is an acidic dye, a metal complex salt dye or a direct dye; and the natural or synthetic fiber material is subjected to a pre-treatment by a pH controller and a moisture-retaining agent in advance (claim 19).

The present invention further provides a natural or synthetic fiber material subjected to a transfer printing process under the dry transfer printing method according to any of claims 15 to 19 (claim 20).

### EFFECT OF THE INVENTION

The transfer paper for dry transfer printing according to the present invention is applicable to the dry transfer printing on a natural fiber material such as a cellulose-based fiber or a protein-based fiber, and on a synthetic fiber material. The dry transfer printing method according to the present invention employing the transfer paper for dry transfer printing enables executing quick delivery by the plateless printing and easily producing a delicate and high-quality design which has been unobtainable, thereby providing a high-quality transfer-printed product. Also, a fiber product having comfortable texture can be obtained, and besides eminently beneficial effects can be attained, such as elimination of the need to prepare the surplus paste, which facilitates executing a small-lot production, and achievement of lower cost and ecological benefit.

The present invention allows, therefore, constructing an industrial manufacturing system capable of quickly and efficiently coping with the small multiproduct production and a wide variety of needs which have come to be an essential requirement. The present invention also provides a high-quality and functional transfer paper with which people can easily enjoy printing at home with an iron or the like. Thus, the present invention not only simplifies the printing technique which has so far been complicated thereby creating an advantage in the industrial production, but also provides a special effect that anybody can choose a favorite design and print, at any convenient place, that design clearly and fast on various fiber materials and obtain excellent texture.

Also, the dry transfer printing method according to the present invention has the advantage that a heating transfer equipment (dry transfer equipment or foil transfer equipment) widely used for dry transfer printing on polyester fibers can be applied as it is, thus offering eminent practical usefulness. Further, although for example two properties of the transfer paper, the stability (the property not being decomposed or peeled off, hence not staining the periphery, during the storage of the transfer paper) and the transfer performance (capability of efficiently and cleanly transferring the dye through a short-time heat treatment) are contradictory to each other, the transfer paper for dry transfer printing according to the present invention harmonizes those contradictory properties, to thereby validate both of them.

Further, the present invention is applicable to a single-phase process dry transfer printing method for the cellulose-based fiber, the protein-based fiber, or the synthetic fiber to be described in details later, which have so far been considered to be difficult, and has therefore established, overcoming various difficulties, a method that allows easily expressing a delicate printed design with high reproducibility. Therefore, the present invention is a peerless new technique. The single-phase process dry transfer printing method eliminates the need to apply an alkaline process to the fiber material, the object to which the design is to be transferred, thereby allowing anybody to easily execute the transfer with a simple equipment. Thus, the present invention has an outstanding significance in that it has established such single-phase process dry transfer printing method.

As described above, the present invention not only provides such advantages in quality that a delicate design can be easily obtained, that a dye having high fastness such as the reactive dye can be employed, and that a fiber product having excellent texture can be obtained, but also offers high compatibility with the environment and economical benefit. The present invention is a novel technique that greatly contributes to the improvement in quality and added value of the printed fiber products.

### PREFERRED EMBODIMENT OF THE INVENTION

The transfer paper for dry transfer printing according to the present invention is characterized in that it has an ink-receiving layer formed on a release agent layer, that the ink-receiving layer contains a hydrophilic synthetic resin and a hydrophilic paste in a proportion of 1 to 50 parts by weight of the hydrophilic paste against 100 parts by weight of the hydrophilic synthetic resin.

In the case where the ink-receiving layer is composed exclusively of the hydrophilic synthetic resin, or of the hydrophilic paste, it is difficult in either case to control the thickness of the layer, which may lead to the drawback that the transfer performance is degraded. The present inventors have studied on this point, and discovered that composing the ink-receiving layer with the hydrophilic synthetic resin and the hydrophilic paste, in such a proportion range as 1 to 50 parts by weight of the hydrophilic paste against 100 parts by weight of the hydrophilic synthetic resin, not only minimizes the foregoing drawback, but also upgrades the transfer paper in other aspects such as stability, thus accomplishing the present invention.

Here, the hydrophilic synthetic resin is the component predominantly constituting the ink-receiving layer, and softens or melts when the transfer paper is heat-pressed against the fiber material (cloth), and is peeled off from the release agent layer to be transferred to the cloth, and then washed away by water after fixation, thus to be removed. Employing thus the hydrophilic synthetic resin as the primary component of the ink-receiving layer leads to harmonization of the contradictory properties of high transfer performance and stability, to thereby validate both of them. Accordingly, it is preferable that the hydrophilic synthetic resin has the nature of softening or melting when heated (claim 2), and that the property thereof satisfies the following requirements.

1. Uniform adhesion on the layer of the solvent type release agent, in other words no water repelling during the coating process.

2. High adhesion performance that will not incur a crack or peeling during operation or storage.

3. High compatibility with the dye, so as not to disturb fixation.

4. Easy drying after the application, free from a tack or stain due to contacting the dye already printed.

5. High transfer performance to the cloth by heat-pressing.

6. Easy cleaning after the dye fixation process, to be easily removed so as not to degrade the texture of the fiber.

7. High compatibility with the surface tension reducer, resin, paste, fixing agent of the reactive dye, and anti-drying agent for the printing dye solution, which may be added as the case may be.

Examples of the hydrophilic synthetic resin include a water-soluble polyester resin, a water-soluble urethane resin, a water-soluble urethane-modified ether resin, and a water-soluble polyethyleneoxide resin.

The hydrophilic paste contained in the ink-receiving layer is added for temporarily fixing to the transfer paper the dye in the dye ink applied to the ink-receiving layer, and serves to retain the design of the dye in a clear state on the paper. The hydrophilic paste is also peeled off from the release agent layer while the transfer paper is heat-pressed to the fiber material (cloth), to be transferred to the cloth and washed away by water after fixation, thus to be removed. Accordingly, it is preferable that the property of the hydrophilic paste satisfies the following requirements.

1. High compatibility with the hydrophilic synthetic resin.

2. High compatibility with the dye, so as not to disturb fixation after the transfer.

3. Flexible and strong film when dried, so as not to incur a crack or peeling in a dynamic handling.

4. Quick and uniform absorption and retention of the dye ink in the layer containing the hydrophilic paste upon performing the ink-jet printing, and quick drying so as to prevent a contact stain due to rubbing of the dye.

5. Easy peeling off from the release agent layer together with the hydrophilic synthetic resin through the heat-pressing process, for easy transfer to the cloth.

6. Easy removal by cleaning after the dye fixation process.

The hydrophilic synthetic resin and the hydrophilic paste composing the ink-receiving layer may be mixed or may form two layer structures. That is, the ink-receiving layer may be composed of a mixture of the hydrophilic synthetic resin and the hydrophilic paste or has a two-layer consisting of a layer composed of the hydrophilic synthetic resin and a layer formed thereon composed of the hydrophilic paste.

In the case where a large amount of hydrophilic paste, for example the ink-receiving layer containing the hydrophilic synthetic resin and a large amount of hydrophilic paste, is brought into direct contact on the release agent layer, the peeling performance of the ink-receiving layer during the heat-pressing is prone to be degraded, and the transfer performance of the dye to the cloth and the reproducibility of the transference are prone to be degraded, however forming the ink-receiving layer in two layers as described above provides the advantage of preventing such problem.

Although the two-layer structure offers the foregoing advantage, it is preferable from the viewpoint of the production efficiency that the ink-receiving layer is formed in a single layer of a mixture of the hydrophilic synthetic resin and the hydrophilic paste. Adjusting the ratio of the hydrophilic synthetic resin and the hydrophilic paste as specified above enables preventing the ink-receiving layer from being peeled off merely by pressing despite being formed in one layer, and preventing the degradation in transfer performance of the dye to the cloth and the reproducibility of the transference.

In the case where the ink-receiving layer is formed in a single layer containing the mixture of the hydrophilic synthetic resin and the hydrophilic paste, and in the case where the hydrophilic synthetic resin, the hydrophilic paste, and the ink-receiving layer contain the chemicals mentioned bellow, an application paste containing these chemicals (hereinafter, “ink-receiving layer forming paste” in some cases) may be applied to the release agent layer to thereby form the ink-receiving layer.

The ink-receiving layer comprises the hydrophilic synthetic resin and the hydrophilic paste as its essential components and may further comprises an acidic substance or an alkaline chemical, a surface tension reducer, a thickening agent, a foil transfer binder paste, a mineral and a moisture-retaining agent in order to improve its properties in some cases.

The foil transfer binder paste softens at a low temperature and is employed for promoting the transference of the hydrophilic synthetic resin, and the examples include known materials composed based on nylon powder, acrylic-based resin and so on. It is preferable that the property of the foil binder paste satisfies the following requirements.

1. Effective for shortening the time for transference

2. High compatibility with the hydrophilic synthetic resin and the hydrophilic paste, and further with an alkaline chemical for dye fixation and a moisture retaining agent if added, and high stability in paste viscosity.

3. Quick drying of the ink-receiving layer forming paste, so as to prevent a contact stain due to abrasion.

4. Easy removal by cleaning after the dye fixation process.

Depending on the type of the hydrophilic synthetic resin, water may be repelled upon application to the release agent layer, thus impeding uniform adhesion to the release agent. The surface tension reducer is employed for preventing the water repellence to thereby improve the uniformity in adhesion to the release agent layer. The surface tension reducer can be exemplified by an anion surfactant, and a preferable amount to be added is 0.1 to 3% (hereinafter, % designates a weight %.) of the ink-receiving layer forming paste, though the optimal combination has to be checked and adjusted in advance, because the extent of the water repellence and the effect of the surface tension reducer are different depending on the type of the chemical (anion-based or nonion-based surfactant, alcohol family, and so on) and the mixing ratio, and also on the type of the hydrophilic synthetic resin, solid content, viscosity at the time of application, type of the release agent, and so forth.

The moisture-retaining agent is employed when necessary, for preventing a crack or peeling off which may be incurred during a dynamic handling of the ink-receiving layer, and can be exemplified by polyethylene glycol (MW200 to 600) and glycerin. The preferable amount to be added of such anti-drying moisture-retaining agents is approx. 0 to 3% against the ink-receiving layer forming paste.

The thickening agent is employed when necessary, for increasing the viscosity of the ink-receiving layer forming paste at the time of application, and can be exemplified by an acrylic acid-based synthetic paste, the preferable amount to be added of which is 0 to 3% against the ink-receiving layer forming paste. The mineral is added, when necessary, for promoting the absorption of the dye ink into the ink-receiving layer and improving the drying performance of the surface, and can be exemplified by silica, diatomite, china clay, and acidic clay.

Further, in the case where the reactive dye is employed as described later, it is preferable to add the alkaline chemical or the moisture retaining agent to the ink-receiving layer, because the addition enables performing the single-phase process transfer printing. To the ink-receiving layer, other resins, other pastes, fixing chemical for the reactive dye, anti-drying agent for the printing dye solution and so on may further be added, for adjusting the water repellence, drying performance, and stability of viscosity.

The content of the chemicals in the ink-receiving layer forming paste is adjusted, based on conversion to solid contents, in a range of 10 to 30% for the hydrophilic synthetic resin, 0 to 30% for the foil transfer binder paste, 0 to 10% for the acidic substance or the alkaline chemical (in the case of the reactive dye, 2 to 10% for the alkaline chemical), 0 to 10% for the moisture-retaining agent for promoting dye fixation, 0.5 to 10% for the hydrophilic paste, and water for the remaining portion.

Also, the total solid content in the ink-receiving layer forming paste is preferably adjusted to be in such a range that the viscosity of the ink-receiving layer forming paste becomes 30000 mPa/s or lower, more preferably 3000 to 20000 mPa/s, so as to attain an excellent application performance. Preferably, the application amount of the ink-receiving layer forming paste is 20 to 100 g/m² when wet, and 10 to 50 g/m² when dry, in a thickness of approx. 10 to 60 μm. The application thickness largely affects the difficulty level for the resin to soften, melt and be transferred to the cloth, and the removal performance by the cleaning after the dye fixation process, and therefore it is essential to control the application amount when employing a coating machine.

Examples of the paper or film used to form the transfer base paper according to the present invention include a paper made from a pulp such as a craft pulp, a ground pulp, a pulp made from recycled paper, the recycled paper, and a heat-resistant synthetic resin film such as a polyester film. From the viewpoint of work efficiency, it is preferable that the weight (basis weight) is 10 to 150 g/m², and the thickness approx. 0.01 to 0.5 mm.

The transfer base paper is made by forming a release agent layer on the paper or film. The release agent layer preferably is a synthetic resin layer soluble in an organic solvent (claim 9). Examples of the synthetic resin soluble in an organic solvent include a silicon resin, a fluorine resin, a polypropylene resin, a polyethylene resin, an acrylic resin, an alkyd resin, a polyamide resin, a phenol resin, a stearic acid resin and a polyester resin, which are soluble in an organic solvent. These resins can be used singly or as a mixture of two or more.

The release agent layer is formed through dissolving the organic solvent-soluble synthetic resin in an organic solvent such as ethyl acetate, toluene, xylene, methanol, ethanol, or propylalcohol, to thereby give an organic solvent varnish, and applying the organic solvent varnish to the foregoing paper or film. The thickness of the release agent layer is preferably approx. 10 to 30 μm. As the transfer base paper, for example a commercially available polyethylene laminated craft paper may also be employed.

The water-soluble dye ink may be an ink of a dye selected from a reactive dye, an acidic dye, a metal complex salt dye and a direct dye. Kind of the dye is chosen according to the kind of the fiber of the cloth. For example, if the fiber material to be transfer printed is a natural fiber material such as cotton, an ink containing a reactive dye (a reactive dye) is most preferable as the water-soluble dye ink.

Examples of the dye ink include one made by mixing a dye, a dye solvent and an anti-drying agent, with the addition of, if necessary, a surface tension reducer, a viscosity controller, a pH controller, an antifungal agent, a preservative, a chelating agent, an antistatic agent and so on, and by being filtered to remove a trace of insoluble residue.

For example, for the reactive dye a commercially available liquid or powder of the reactive liquid, or an aqueous solution of a chromogen can be employed, and it is preferable to prepare the reactive dye based on those materials with appropriate additives, selected in consideration of the two aspects of prevention of nozzle clogging of the ink-jet printer and drying performance of the dye printed on the transfer paper.

More specifically, as the solvent of the reactive dye or the anti-drying agent, 5 to 10% of e-caprolactum, a glycol such as ethylene glycol, diethylene glycol, triethylene glycol, or polyethylene glycol MW200 to 600, aromatic acid amide, fatty acid ether and so on against the ink, 0.1 to 0.5% of chelating agent such as disodium EDTA, sodium hexamethaphosphate or the like, and 0.05 to 0.5% of a preservative/antifungal agent such as benzoimidazole-based, sodium benzoate, organic iodine-based, organic phosphorus-based, or organic phosphorus nitride-based compound may be added to the ink, followed by adjustment of the dye concentration with ion-exchanged water and the pH value, preferably in a range of 7±1.

Then the dye solution thus obtained is filtered to thereby remove a trace of foreign substance thus to be refined, and at this stage the reactive dye ink for ink-jet printing is obtained.

The transfer paper for dry transfer printing according to the present invention can be formed through printing the dye ink prepared as described above on the foregoing uncolored transfer paper, in other words the uncolored transfer paper made by applying the ink-receiving layer to the transfer base paper, by ink-jet printing or any other method, to thereby apply a design such as illustration, a figure, or a pattern, and then drying.

Here, naturally the design or color can be applied to the uncolored transfer paper not only with the ink-jet printer, but also by any desired method such as machine printing, hand printing, hand drawing or printing, upon adjusting the viscosity of the ink with the paste. In the case of drawing the design with a Japanese traditional dyeing technique such as the hand-painted Yuzen, it will be even possible to create an artistic sewn product that is unique in the whole world.

In the case where the water-soluble dye ink is the reactive dye ink, the transfer paper for dry transfer printing according to the present invention can be applied to the single-phase process transfer printing method, which will be described later, upon adding the alkaline chemical to the ink-receiving layer.

Now the single-phase process printing and the double-phase process printing will be described. The known direct printing method of the reactive dye includes the single-phase process and the double-phase process. To be more detailed, whereas it is indispensable to add the alkaline chemical in order to fix the reactive dye to the fiber, the process of adding the alkaline chemical to the cloth is classified into the single-phase process and the double-phase process.

The single-phase process includes mixing the reactive dye and the alkaline chemical, applying at the same time to the cloth, and executing the fixation process by drying and steaming, and is employed in the direct printing with a substitution reactive dye such as chlorotriazine type reactive dye. This process cannot be applied to an alkali-sensitive dye.

The double-phase process includes separately applying the reactive dye and the alkaline chemical to the cloth for the fixation process, which can be performed in the following two procedures, and is widely utilized for the direct printing with an addition type reactive dye such as a vinylsulfone type reactive dye.

1. Alkali-first process: The alkaline chemical is first added and the cloth is dried, after which the dye is printed and steaming is executed for fixation.

2. Alkali-after process: The dye is printed on the cloth, after which the alkaline process is executed (soaking the cloth in the alkali at a predetermined temperature and for a predetermined time).

Whichever the case may be, the fixation process is followed by the cleaning and drying process, thus to obtain the finished product.

Although the present invention can be applied for a single-phase process and a double-phase process in the direct printing method, it is preferably applied for the single-phase process. The single-phase process is called as a single transfer printing method which is the most preferable embodiment of the present invention.

On of the most important objects of the present invention is to provide a single-phase process transfer printing method that offers excellent texture, delicacy, and fastness, and the most important task of the present inventors in their research and development activities lies in establishing the technique of making the single-phase process dry transfer printing method practicable, thereby simplifying the high-level and complicated printing technique for not only making it industrially advantageous but also for enabling the public to select a favorable design and to print that design, at any convenient location, on a fiber material clearly and fast, attaining at the same time excellent texture.

In a printing process that employs the reactive dye, generally, the mixture system in which the dye, water and the alkali coexist is prone to incur hydrolysis of the dye, which leads to defective fixation of the dye. On the other hand, the transfer paper for dry transfer printing according to the present invention is free from water, and hence the hydrolysis is alleviated and even an alkali-sensitive dye can be employed. Whereas it is indispensable to employ the moisture-retaining agent that promotes the intrusion and dispersion of both the dye and the alkali into the fiber in order to fix the dye to the cloth, in the case of employing the conventional technique to print the dye solution on the uncolored transfer paper including the moisture-retaining agent, the dye bleeds because the majority of the moisture-retaining agents is deliquescent, thus failing in expressing a delicate design.

Also, contradictory properties that are difficult to be fully exhibited at the same time are involved in the conventional technique, for example the adhesion performance and peeling performance of the ink receiving layer on the uncolored transfer paper are in a trade-off relationship, such that if the adhesion of the ink-receiving layer is made stronger the transfer performance is degraded though the stability of the transfer paper is improved, while if the peeling performance is upgraded, though the transfer performance is improved the stability of the transfer paper is degraded incurring a problem in preservation of the transfer paper. Thus, under the conventional technique, the transfer paper that easily performs the transfer by pressure is not a transfer paper that stands a reasonable preservation condition.

The present inventors have perseveringly continued the research and experiments, to finally discover the solution of numerous difficult issues including the transfer performance, transfer paper stability, clearness of the printed design, fixation performance, cleaning performance, and the texture of the fiber, through sorting out the composition balance of multiple components based on the selection and optimization of various chemicals to be added to the composition of the ink-receiving layer forming paste, resulting in successfully establishing a highly practical, peerless novel technique that is not only industrially advantageous, for example because the pre-treatment of the cloth can be skipped, but also applicable to home use.

In the case of applying the present invention to the single-phase process transfer printing method utilizing the reactive dye, the alkaline chemical for fixing the reactive dye to the fiber, and the moisture-retaining agent for promoting the intrusion, dispersion and fixation of the dye to the fiber are contained in the ink-receiving layer together with the foregoing other chemicals. The transfer paper for dry transfer printing according to the present invention is formed in the optimal composition ratio, so that the effect of each component is exhibited to its fullest extent as an all-in-one system, and based on such transfer paper, the dry transfer printing method that eliminates the complication of the printing procedure and offers upgraded reproducibility is provided.

Here, it is preferable that the property of the alkaline chemical satisfies the following requirements.

1. High solubility in the ink-receiving layer.

2. Effective promotion of the reactive dye for fixation.

3. High stability in viscosity in the ink-receiving layer.

4. High durability and stability of the above effects on the uncolored transfer paper.

5. Quick drying after application of the ink-receiving layer, so as not to produce a tack.

Examples of the effective alkaline chemical include a carbonate, a phosphate, a silicate and an acetate of an alkaline metal or an alkaline earth metal. Above all, a salt of a weak acid and a strong alkali is preferable (claim 14) in order to prevent the hydrolysis of the dye and create a delicate design, and specific examples include a carbonate alkali such as sodium carbonate, potassium carbonate, sodium sesquicarbonate, sodium bicarbonate, potassium bicarbonate, lithium carbonate, sodium phosphate, sodium silicate, sodium acetate, or sodium trichloroacetate.

It is preferable that the property of the moisture-retaining agent to be used with the alkaline chemical satisfies the following requirements.

1. High and uniform solubility and dispersion in the composition of the ink-receiving layer forming paste

2. Quick drying, so as not to produce a tack.

3. Capability of preventing the bleeding upon printing, for clear expression of the design.

4. Capability of promoting the transfer of the dye, and contributing to the intrusion, dispersion and fixation of the dye in the steaming process.

5. No deliquescence during the storage of the transfer paper.

Examples of the moisture-retaining agent that satisfies these requirements include compounds popularly called hydrotropes, specifically urea, thiourea, e-caprolactum, dicyandiamide, formaldehyde, acetamide, thiocyanate, toluenesulfonate, and so forth.

The dry transfer printing method of the present invention is a method comprising heat-pressing the above-mentioned transfer paper of the present invention a natural or synthetic fiber material, to thereby transfer the water-soluble dye ink (design) etc. retained by the transfer paper to the fiber material, followed by executing a fixing process, for example, by a steaming process.

To be more detailed, the transfer paper for dry transfer printing according to the present invention and the object cloth are put together, and preferably 90% or more, more preferably generally 100% of the ink-receiving layer and the dye layer are made to transfer to the cloth by heat-pressing, after which the fixation process is executed so as to fix the dye to the cloth. After the dye fixation, the cleaning process (water washing, soaping, water washing) is performed to remove the resin, chemical and paste utilized as the ink-receiving layer, to thereby obtain a printed cloth having excellent fiber texture, or a printed sewn product.

Examples of the natural or synthetic fiber material used in the dry transfer printing method of the present invention include a woven, a knitted, and a non-woven fabric made of one or at least two fiber materials selected from a cellulose-based fiber material such as cotton, hemp, lyocell, and rayon (polynosic rayon, viscose rayon, cupra rayon and so on), a protein-based fiber material such as silk, wool, and animal hair, and a synthetic fiber material such as nylon, vinylon, and so forth. It may be a blend fiber, a mixed weaving fabric, or a combined weaving product comprising the above-exemplified fiber materials. Paper and the like are included in the natural or synthetic fiber material.

When the water-soluble dye ink comprises a reactive dye, the dry transfer printing method of the present invention is applied to a natural fiber material, for example. In this case, using a transfer paper for dry transfer printing having an ink receiving layer comprises an alkaline chemical and a moisture retaining agent, a single-phase process transfer printing method can be conducted.

On the other hand, using a water-soluble dye ink comprises a reactive dye and a transfer paper for dry transfer printing having the ink receiving layer comprising no alkaline chemical, the fiber material needs to be subjected to a pre-treatment by an alkaline chemical, a moisture retaining agent and other required chemicals in advance. For example, an aqueous solution containing 3 to 15% of sodium carbonate, potassium carbonate, sodium bicarbonate, sodium silicate, sodium trichloroacetate, and the like, 3 to 25% (preferably 5 to 20%) of urea as a moisture retaining agent for preventing yellowing on the transfer, improving transfer performance, improving fixation by accelerating penetration and diffusion of the dye, and 0.05 to 1% of a hydrophilic thickening agent such as sodium alginate as an anti-migration agent is pad-dried on a cloth.

The dry transfer printing method according to the present invention is also applicable to the case where an acidic dye, a metal complex salt dye, or a direct dye is employed as the water-soluble dye, other than the reactive dye. In this case, the natural or synthetic fiber material should be subjected to a pre-treatment with the pH controller, the moisture-retaining agent, and other chemicals as the case may be. For example, in the case of printing with an acidic dye, aqueous solution containing 0.5 to 5% of acid ammonium salt as the pH controller (fixation promotor), such as ammonium sulfate, ammonium nitrate, or ammonium tartrate, and 0.05 to 0.5% of paste as anti-migration agent, is employed for pad-drying.

To fix the dye to the fiber after the transference, the fixing conditions applied to the ordinary direct printing method can be adopted as they are. For example, in the case of executing the single-phase process transfer printing method with the reactive dye, the fixing conditions specified for the single-phase process direct printing method can be adopted, and it is appropriate, for example in the normal pressure steaming process (100 to 105° C.), to execute the steaming for 5 to 20 minutes (more preferably 8 to 15 minutes) under a humidity of 90 to 100RH %.

With a cloth not subjected to the alkali pre-treatment, for example a double-phase alkali shock process is performed, which includes soaking the cloth in hot solution of sodium silicate of 90 to 95° C. and 40 to 45 baume for 7 to 15 seconds, and alternatively a double-phase cold fix process is employed in which the cloth is padded in a sodium silicate solution of 35 to 43 baume and wrung (pick-up 100 to 150%), followed by a batch-up process of 8 to 12 hours at 20 to 35° C.

In the case where the acidic dye is employed, a steaming process is performed at 100 to 105° C., for 10 to 30 minutes.

After the dye fixation, the synthetic resin, paste and so on utilized in the ink-receiving layer are removed through an ordinary cleaning process (water washing, soaping, water washing), thus to obtain a printed product having excellent fiber texture. Here, taking into account the fact that the transfer paper used for printing can be recycled as the transfer base paper, and that besides the load of waste water to the environment from the cleaning water of the printed cloth is small because the cloth bears only a small amount of residue of the paste, the method according to the present invention can be appreciated to be ecologically friendly.

### Example

Hereunder, the present invention will be described in further details with working examples, however it should be understood that the present invention is not limited to these examples. All the percentage values represent the weight %.

### Example 1

An organic solvent varnish (phenol resin 30%, ethylcellulose 3%, calcium carbonate 10%, clay 10%, ethylacetate 47%) was applied as the release agent to a transfer pulp paper (weight 90 g/m², thickness 0.2 mm) with a coating machine, and cured at 140° C. for three minutes after drying. The thickness of the release agent layer was 30 μm.

Then a mixture (ink-receiving layer forming paste) of total 100%, composed of Plascoat Z-221 (hydrophilic synthetic resin: 25% disperse solution of water-soluble polyester resin, from Goo Chemical Co., Ltd.) 55%, binder TFG-218 (foil transfer nylon resin paste from Matsui Shikiso Chemical Co., Ltd.) 10%, Meisanol TR (anion-based surfactant from Meisei Chemical Works, Ltd.) 1%, soda ash (reactive dye fixing alkali) 3%, e-caprolactum 5%, thiourea 3%, and Ecoalgin MS (hydrophilic paste: 5% paste of sodium alginate from ATI Co., Ltd.) 15%, thickening agent-F (acrylic-based synthetic resin from Sano Co., Ltd) 3% (the remaining portion was adjusted with water), was applied as the ink-receiving layer with a coating machine, and then dried. This coating layer had a thickness of approx. 30 μm. Thus, the dry uncolored transfer paper was made up for the single-phase process with the reactive dye.

Thereafter, the reactive dye solution for ink-jet printing was made up from Kayacion Scarlet P-RN liquid 33 (C.I. Reactive Red 33) 50%, polyethyleneglycol (MW200) 2%, disodium EDTA 0.3%, Amolden FS-140 (organic phosphorus nitride-based preservative/antifungal agent from Daiwa Chemical Industry Co., Ltd.) 0.1%, and ion-exchanged water for the remaining portion to make the total of 100%. The solution was then filtered to remove insolubles, thus to obtain the reactive dye solution for ink-jet printing. Such dye ink was printed on the uncolored transfer paper with an ink-jet printer (Novajet II from Encad Inc., on-demand type thermal printer) and dried, to thus make up a transfer paper for dry transfer printing having a design.

A silk satin cloth and a cotton broad cloth were put together with the transfer paper, and heat-pressed (130 to 160° C., 1 to 3 seconds, 2 kg/cm²) to transfer the design to the cloths. The transference rate of the dye from the transfer paper to the silk and cotton cloth was 100%. The cloths with the dye transferred thereto were subjected to a steaming process under normal pressure at 100° C. for 15 minutes, followed by cleaning and drying. The printed cloths thus obtained showed a delicate design fixed thereon clearly and fast, and the texture was soft.

The same procedures were repeated except that the ink-jet printer, Novajet II from Encad Inc., on-demand type thermal printer, is changed to HYPERECO from MUTOH Industries Ltd., on-demand type piezo ink-jet printer, almost same results were obtained.

### Example 2

As the transfer base paper, a commercially available polyethylene laminate pulp paper (weight 90 g/m², thickness 0.2 mm) was used. On the transfer base paper, an ink-receiving layer forming paste composed of HA resin PE-1B (hydrophilic synthetic resin: 25% viscous solution of water-soluble urethane modified polyether resin, from Meisei Chemical Co., Ltd.) 50%, binder TFG-1215 (foil transfer nylon resin paste from Matsui Shikiso Chemical Co., Ltd.) 15%, Plascoat RY-2 (fluorine containing surface tension reducer 10% solution, from Goo Chemical Co., Ltd.) 0.5%, potassium carbonate (reactive dye fixing alkali) 2.5%, thiourea 7%, Sorbitose C-5 (hydrophilic paste: paste for temporally fixation of printing dye: 10% paste of etherified starch, from AVEBE Co., Ltd.) 18%, thickening agent-F (acrylic-based synthetic resin from Sano Co., Ltd) 2% and ion-exchanged water for the remaining portion to make the total of 100% was applied as the ink-receiving layer with a coating machine, and then dried. This coating layer had a thickness of approx. 30 μm. Thus, the dry uncolored transfer paper was made up for the single-phase process with the reactive dye.

Thereafter, the reactive dye solution for ink-jet printing was made up from Kayacion Turquoise P-NGF liquid 33 (C.I. Reactive Blue 15) 50%, ethyleneglycol 7%, sodium hexametha phosphate 0.3%, Amolden FS-140 0.1%, and ion-exchanged water for the remaining portion to make the total of 100%. The solution was then filtered to remove insolubles, thus to obtain the reactive dye solution for ink-jet printing. Such dye ink was printed on the uncolored transfer paper with the ink-jet printer mentioned above and dried, to thus make up a transfer paper for dry transfer printing having a design.

A rayon cloth was put together with the transfer paper, and heat-pressed (130 to 160° C., 1 to 3 seconds, 3 kg/cm²) to transfer the design to the cloths. The cloths with the dye transferred thereto were subjected to a steaming process under normal pressure at 100° C. for 15 minutes, followed by cleaning and drying. The printed cloths thus obtained showed a delicate design with high resolution, the finish was clear and fast, and the cloth had excellent texture. It should be noted that upon employing a rayon cloth subjected to pad-drying in 10% urea solution for this transfer printing, the dye more thoroughly intruded to express the printed design.

### Example 3

An organic solvent varnish, the same varnish as that used in Example 1, was applied as the release agent to a transfer pulp paper (weight 70 g/m², thickness 0.15 mm) with a coating machine. Then an ink-receiving layer forming paste of total 100%, containing Plascoat Z-850 (hydrophilic synthetic resin: 25% disperse solution of water-soluble polyester resin, from Goo Chemical Co., Ltd.) 15%, P-topink (nylon resin paste for flocked pile from Matsui Shikiso Chemical Co., Ltd.) 10%, anti-eye hole agent-1004 (Anion activator type surface tension depressant from Sano Co., Ltd.) 1.5%, soda ash (reactive dye fixing alkali) 3%, e-caprolactum (moisturizing agent for dyeing promotion) 5%, Ecoalgin MS (hydrophilic paste: 5% paste of sodium alginate from ATI Co., Ltd.) 10% and thickening agent-F (acrylic-based synthetic resin from Sano Co., Ltd) 4%, was applied as the ink-receiving layer with a coating machine, and then dried. This coating layer had a thickness of approx. 25 μm. Thus, the dry uncolored transfer paper was made up for the single-phase process with the reactive dye.

Thereafter, the reactive dye solution for ink-jet printing was made up from Kayacion Scarlet P-3R powder (C.I. Reactive blue 49) 15%, thiodiethyleneglycol (dry suppressant, dye solubilizer) 10%, sodium hexametaphosphates (metal ion sealant) 0.3%, Amolden FS-140 0.1%, and ion-exchanged water for the remaining portion to make the total of 100%. The solution was then filtered to remove insolubles, thus to obtain the reactive dye solution for ink-jet printing. Such dye ink was printed on the uncolored transfer paper with an ink-jet printer and dried, to thus make up a transfer paper for dry transfer printing having a design.

A silk satin cloth was put together with the transfer paper, and heat-pressed (130 to 160° C., 1 to 3 seconds, 2 kg/cm²) to transfer the design to the cloths. Then, the cloths were subjected to a steaming process under normal pressure at 100° C. for 20 minutes, followed by cleaning and drying. The printed cloths thus obtained showed a delicate design having definite and clear tone contrast, and have good fastness and excellent texture.

### Example 4

An organic solvent varnish (phenol resin 30%, ethylcellulose 3%, calcium carbonate 10%, clay 10%, ethylacetate 47%) was applied as the release agent to a transfer pulp paper (weight 90 g/m², thickness 0.2 mm) with a coating machine, and cured at 140° C. for three minutes after drying. The thickness of the release agent layer was 30 μm.

Then an ink-receiving layer forming paste of total 100%, containing Plascoat Z-450 (hydrophilic synthetic resin: 30% disperse solution of water-soluble polyester resins from Goo Chemical Co., Ltd.) 75%, Meisanol TR (anion-based surfactant from Meisei Chemical Works, Ltd.) 1%, glycerin 3%, Sorbitose C-5 (hydrophilic paste: 10% paste of etherified starch, from AVEBE Co., Ltd.) 20% and thickening agent-F (acrylic-based synthetic resin from Sano Co., Ltd) 1%, was applied as the ink-receiving layer with a coating machine, and then dried. This coating layer had a thickness of approx. 30 μm. Thus, the dry uncolored transfer paper was made up for water-soluble dye.

Thereafter, a reactive dye ink (C.I. Reactive Red 226, a powder product: 15%, ethyleneglycol base moisturizer: 20%, water 65%) was printed on the above-mentioned uncolored transfer paper with an ink-jet printer (Novajet II from Encad Inc., on-demand type thermal printer) and dried, to thus make up a transfer paper for dry transfer printing having a design. Separately, an aqueous solution of mixture of soda ash (reactive dye fixing alkali) 8%, urea 20%, Ecoalgin MS 0.1% and Nicca silicone GA-7000 (temporally softener from NICCA Chemical Co., Ltd.) is padded on a cotton broad cloth (pick up 75%) and then dried to make up a pretreated cotton cloth.

Thereafter, the transfer paper and the alkaline pretreated cotton broad cloth were put together, and heat-pressed (130° C., 30 seconds, 0.2 kg/cm²) to transfer the design to the cotton broad cloth. The transference rate of the dye from the transfer paper to the cotton broad cloth was about 100%. Then, the cotton broad cloth was subjected to an HT steaming process at 105° C. for 8 minutes, followed by cleaning and drying. The printed cloths thus obtained showed a delicate design fixed thereon clearly and fast, and the texture was soft. The same procedures in this example were repeated except that the foil transfer binder paste containing nylon powder as a main ingredient is added to the ink-receiving layer at the amount of 10%, the time required for the transfer is shortened to be about one-fifth.

[Comparative Data]

Table 1 shows test results regarding the uniformity of printing effect and transfer performance to the cotton cloth, under various conditions in the case of printing the dye ink on the uncolored transfer paper. In other words, the table indicates comparative data showing what difference is produced depending on the type of the varnish employed as the release agent layer and on compositions of the ink-receiving layer, from the process according to the Example 4.

TABLE 1

| | | | | | transfer |
|---|---|---|---|---|---|
| | Content of Transfer paper | | uniformity | | performance |
| | release agent | ink-receiving | of printing | contact | to the cotton |
| No. | layer | layer | effect * | stain | cloth |
| (1) | water-soluble | No ink-receiving | ◯- | ◯ | X |
| | varnish | layer | | | |
| (2) | organic solvent- | | X | ◯ | X |
| | soluble varnish | | | | |
| (3) | water-soluble | Water-soluble | ◯ | Δ | Δ-X |
| | varnish | synthetic resin + | | | |
| (4) | organic solvent- | surface tension | ◯ | X | ◯-Δ |
| | soluble varnish | reducer | | | |
| (5) | water-soluble | Water-soluble | ◯ | ◯ | Δ-X |
| | varnish | synthetic resin + | | | |
| (6) | organic solvent- | surface tension | ◯ | ◯ | ◯ |
| | soluble varnish | reducer + Paste | | | |

(6) is an example of the present invention.
* uniformity of ink-receiving agent, and uniformity in dyeing effect and water repellence at the printing process
◯: good
Δ: Slightly bad
X: bad

To achieve fine and clear transfer printing, both of the following properties are required.

A. Uniformity in dyeing effect and water repellence at the printing process, and

B. Transfer performance to the cloth and contact stain prevention of the transfer paper

As is apparent from the test results shown in the table, it is only the combination (6) according to the present invention that completely satisfies the both requirements of A and B (including contact stain prevention).

### Example 5

An organic solvent varnish, the same varnish as that used in Example 4, was treated as the release agent to a transfer pulp paper (weight 90 g/m², thickness 0.2 mm). Then an ink-receiving layer forming paste of total 100%, containing HA resin PE-1B (hydrophilic synthetic resin: 25% viscous solution of water-soluble urethane modified polyether resin, from Meisei Chemical Co., Ltd.) 50%, Plascoat RY-2 (fluorine containing surface tension reducer 10% solution, from Goo Chemical Co., Ltd.) 2%, Ecoalgin MS (hydrophilic paste: medium viscosity 5% solution of sodium alginate paste from ATI Co., Ltd.) 20%, was applied as the ink-receiving layer with a coating machine, and then dried. This coating layer had a thickness of approx. 30 μm. Thus, the dry uncolored transfer paper was made up for water-soluble dye.

Thereafter, a reactive dye ink (C.I. Reactive Blue 15, a powder product: 15%, thiodiglycol: 15%, water 70%) was printed on the above-mentioned uncolored transfer paper with an ink-jet printer (Novajet II from Encad Inc., on-demand type thermal printer) and dried, to thus make up a transfer paper for dry transfer printing having a design.

Separately, an aqueous solution of mixture of sodium bicarbonate 8%, urea 20% and Ecoalgin MS (sodium alginate from ATI Co., Ltd.) 0.1% is padded on a viscous rayon cloth (pick up 85%) and then dried to make up a pretreated rayon cloth. Then, the transfer paper and the pretreated rayon cloth were put together, and heat-pressed (140° C., 40 seconds, 0.2 kg/cm²) to transfer the design to the rayon cloth.

The transference rate of the dye from the transfer paper to the viscous rayon cloth was about 100%. Then, the viscous rayon cloth was subjected to an HT steaming process at 105° C. for 8 minutes, followed by cleaning and drying. The printed cloths thus obtained showed a delicate design as the printed cloths in Example 4, the texture was soft, and various fastnesses, such as fastness to light, to washing and to perspiration, are Grade 4 or better.

### Example 6

The same procedures in Example 4 were repeated except that Sorbitose C-5, hydrophilic synthetic paste for ink-receiving layer is replaced by MC polymer P-40 (mixed paste of polyvinyl alcohol and polysodiumacrylate from Murayama Chemical Laboratory Co., Ltd.), and a delicate printed product excellent in uniformity of printing effect at dye printing and in transfer performance to the cotton cloth was obtained.

### Example 7

An organic solvent varnish (phenol resin 30%, ethylcellulose 3%, calcium carbonate 10%, clay 10%, ethylacetate 47%) was applied as the release agent to a transfer pulp paper (weight 90 g/m², thickness 0.2 mm) with a coating machine, and cured at 140° C. for three minutes after drying. The thickness of the release agent layer was 30 μm.

Then an ink-receiving layer forming paste of total 100%, containing Plascoat RZ-142 (hydrophilic synthetic resin: 25% disperse solution of water-soluble polyester resin, from Goo Chemical Co., Ltd.) 72%, Plascoat Z-730 (20% disperse solution of water-soluble polyester resin containing wax, from Coo Chemical Co., Ltd.) 72%, and thickening agent-F (acrylic-based synthetic paste) 3%, was applied as the ink-receiving layer 1 with a coating machine, and then dried. This coating layer had a thickness of 60 μm.

Thereafter, Ecoalgin MS (hydrophilic paste: 2% solution of sodium alginate paste from ATI Co., Ltd.) was applied on the ink-receiving layer 1 with a coating machine and dried to form the ink-receiving layer 2. This coating layer had a thickness of 25 μm. Thus, the dry uncolored transfer paper was made up for water-soluble dye.

Thereafter, a reactive dye ink (C.I. Reactive Red 226, a powder product: 15%, ethyleneglycol base moisturizer: 20%, water 65%) was printed on the above-mentioned uncolored transfer paper with an ink-jet printer (Novajet II from Encad Inc., on-demand type thermal printer) and dried, to thus make up a transfer paper for dry transfer printing having a design.

Separately, an aqueous solution of mixture of soda ash 5%, urea 10%, and Ecoalgin MS 0.1% is padded on a cotton broad cloth (pick up 75%) and then dried to make up a pretreated cotton cloth.

Thereafter, the transfer paper and the above-mentioned cotton broad cloth pretreated with alkali were put together, and heat-pressed (150° C., 30 seconds, 0.2 kg/cm²) to transfer the design to the cotton broad cloth. The transference rate of the dye from the transfer paper to the cotton broad cloth was about 100%. Then, the cotton broad cloth was subjected to an HT steaming process at 105° C. for 8 minutes, followed by cleaning and drying. The printed cloths thus obtained showed a delicate design fixed thereon clearly and fast, and the texture was soft.

### Example 8

An organic solvent varnish, the same varnish as that used in Example 6, was treated as the release agent to a transfer pulp paper (weight 90 g/m², thickness 0.2 mm). Then a mixed solution composed of HA resin PE-1B (hydrophilic synthetic resin: 25% viscous solution of water-soluble urethane modified polyether resin, from Meisei Chemical Co., Ltd.) 40%, Plascoat RY-2 (surface tension reducer from Goo Chemical Co., Ltd.) 7% and water 53% was applied as the ink-receiving layer 1 with a coating machine, and then dried. This coating layer had a thickness of approx. 35 μm.

Then, Sorbitose C-5 (hydrophilic paste: 3% solution of etherified starch paste, from AVEBE Co., Ltd.) was applied as the ink-receiving layer 2 with a coating machine, and then dried. This coating layer had a thickness of approx. 25 μm. Thus, the dry uncolored transfer paper was made up for water-soluble dye.

Thereafter, a reactive dye ink (C.I. Reactive Blue 15, a powder product: 15%, thiodiglycol: 15%, water 70%) was printed on the above-mentioned uncolored transfer paper with an ink-jet printer (Novajet II from Encad Inc., on-demand type thermal printer) and dried, to thus make up a transfer paper for dry transfer printing having a design. Separately, an aqueous solution of mixture of sodium bicarbonate 6%, urea 15% and Ecoalgin MS (sodium alginate from ATI Co., Ltd.) 0.1% is padded on a viscous rayon cloth (pick up 85%) and then dried to make up a pretreated rayon cloth.

Then, the transfer paper and the pretreated cloth were put together, and heat-pressed (135° C., 30 seconds, 0.2 kg/cm²) to transfer the design to the rayon cloth. The transference rate of the dye from the transfer paper to the viscous rayon cloth was about 100%. Then, the viscous rayon cloth was subjected to an HT steaming process at 105° C. for 8 minutes, followed by cleaning and drying. The printed cloths thus obtained showed a delicate design as the printed cloths in Example 7, the texture was soft, and various fastnesses are satisfactory.

### Example 9

The same procedures in Example 7 were repeated except that the synthetic paste for ink-receiving layer is replaced by MC polymer P-40 (mixed paste of polyvinyl alcohol and polysodiumacrylate from Murayama Chemical Laboratory Co., Ltd.), and a delicate printed product excellent in uniformity of printing effect at dye printing and in transfer performance to the cotton cloth was obtained.

### INDUSTRIAL APPLICABILITY

The present invention provides a dry transfer printing method that allows executing quick delivery by what is known as plateless printing, and easily obtaining a delicate, high-quality design that has conventionally been unobtainable, achieving at the same time excellent texture and fastness of the printed product, and the method also eliminates the need of spending a surplus amount of paste, thereby reducing the cost as well as the load on the environment, and thus an ecologically friendly printing method that provides high-quality printed products is established. Thus, the present invention provide an epochal new technology which attains all of high quality, high cost performance, quick delivery, and low load on the environment. Therefore, enormous applicability in dyestuff industry can be predicted.

What is claimed is:

1. A transfer paper for dry transfer printing, to be used in a dry transfer printing process including heat-pressing the transfer paper on a natural or a synthetic fiber material to thereby transfer a design,
formed through applying a water-soluble dye ink,
to an uncolored transfer paper including a release agent layer and an ink-receiving layer formed thereon,
wherein the ink-receiving layer contains a hydrophilic synthetic resin and a hydrophilic paste,
in a proportion of 1 to 50 parts by weight of the hydrophilic paste against 100 parts by weight of the hydrophilic synthetic resin.

2. The present invention also provides the transfer paper for dry transfer printing according to claim 1, wherein the hydrophilic synthetic resin is a resin that softens or melts when heated.

3. The transfer paper for dry transfer printing according to claim 1 or 2, wherein the hydrophilic synthetic resin is one or a mixture of at least two selected from a water-soluble polyester resin, a water-soluble urethane resin, a water-soluble urethane-modified ether resin, and a water-soluble polyethyleneoxide resin.

4. The transfer paper for dry transfer printing according to any of claims 1 to 3, wherein the hydrophilic paste is a paste composed essentially of a natural material, a semi-synthetic material or a water-soluble synthetic polymer.

5. The transfer paper for dry transfer printing according to claim 4, wherein the hydrophilic paste is one or a mixture of at least two selected from a seaweed, a cellulose-derived paste, a modified starch paste, a water-soluble synthetic polymer and a natural gum.

6. The transfer paper for dry transfer printing according to any of claims 1 to 5, wherein the ink-receiving layer is composed essentially of a mixture of the hydrophilic synthetic resin and the hydrophilic paste (claim 6).

7. The transfer paper for dry transfer printing according to any of claims 1 to 5, wherein the ink-receiving layer has a two-layer structure consisting of a layer composed of the hydrophilic synthetic resin and a layer formed thereon composed of the hydrophilic paste.

8. The transfer paper for dry transfer printing according to any of claims 1 to 7, wherein the ink-receiving layer further comprises one or at least two selected from an acidic substance or an alkaline chemical, a surface tension reducer, a thickening agent, a foil transfer binder paste, a mineral and a moisture-retaining agent.

9. The transfer paper for dry transfer printing according to any of claims 1 to 8, wherein the release agent layer is a synthetic resin layer soluble in an organic solvent.

10. The transfer paper for dry transfer printing according to claim 9, wherein the synthetic resin soluble in an organic solvent is one or a mixture of at least two selected from a silicon resin, a fluorine resin, a polypropylene resin, a polyethylene resin, an acrylic resin, an alkyd resin, a polyamide resin, a phenol resin, a stearic acid resin and a polyester resin.

11. The transfer paper for dry transfer printing according to any of claims 1 to 10, wherein the water-soluble dye ink is an ink of a dye selected from a reactive dye, an acidic dye, a metal complex salt dye and a direct dye.

12. The transfer paper for dry transfer printing according to claim 11, wherein the water-soluble dye ink comprises a reactive dye.

13. The transfer paper for dry transfer printing according to claim 11, wherein the ink receiving layer comprises an alkaline chemical and a moisture retaining agent.

14. The transfer paper for dry transfer printing according to claim 13, wherein the alkaline chemical is a salt of a weak acid and a strong alkali.

15. A dry transfer printing method comprising heat-pressing the transfer paper according to any of claims 1 to 14 on a natural or synthetic fiber material, to thereby transfer the water-soluble dye ink retained by the transfer paper to the fiber material, and executing a fixing process.

16. The dry transfer printing method according to claim 15, wherein the fixing process is a steaming process.

17. The dry transfer printing method according to claim 15 or 16, wherein the natural or synthetic fiber material is one of a woven, a knitted, and a non-woven fabric made of one or at least two fiber materials selected from a cellulose-based fiber material, a protein-based fiber material, and a synthetic fiber material.

18. The dry transfer printing method according to any of claims 15 to 17, wherein the water-soluble dye ink comprises a reactive dye; the natural or synthetic fiber material is a natural fiber material; and the natural fiber material is subjected to a pre-treatment by an alkaline chemical in advance.

19. The dry transfer printing method according to any of claims 15 to 17, wherein the water-soluble dye ink is an acidic dye, a metal complex salt dye or a direct dye; and the natural or synthetic fiber material is subjected to a pre-treatment by a pH controller and a moisture-retaining agent in advance.

20. A natural or synthetic fiber material subjected to a transfer printing process under the dry transfer printing method according to any of claims 15 to 19.
